(19) United States
(12) Patent Application Publication
(10) Pub. No.: US 2014/0189571 A1
(43) Pub. Date: Jul. 3, 2014

(54) DISPLAY CONTROL DEVICE, DISPLAY CONTROL METHOD, AND RECORDING MEDIUM

(71) Applicant: NEC CASIO MOBILE COMMUNICATIONS, LTD., Kanagawa (JP)

(72) Inventor: Masato IIZUKA, Kanagawa (JP)

(73) Assignee: NEC CASIO MOBILE COMMUNICATIONS, LTD., Kanagawa (JP)

(21) Appl. No.: 13/730,297

(22) Filed: Dec. 28, 2012

(51) Int. Cl. G06F 3/0484

(52) U.S. Cl. CPC G06F 3/0484
USPC 715/780

(57) ABSTRACT

A display control part 11 displays on a display part 34 an application screen including a symbols display area displaying symbols and a software keyboard. The display control part 11 further displays the symbols entered by the user through touch operation on the software keyboard at a given position in the symbols display area. When a determination part 13 determines that a time t1 has elapsed since the last input operation on the software keyboard, the display control part 11 deletes the display of the software keyboard and extends the symbols display area.

### TECHNICAL FIELD

The present invention relates to a display control device, display control method, and recording medium for controlling display on a screen.

### BACKGROUND ART

When the display screen consists of a touch panel, the user touches input keys displayed on the touch panel. There are techniques for receiving symbols (letters, numbers, etc.) or commands assigned to the input keys touched by the user. For example, the display screens of ATMs (automated teller machines), automatic ticket vending machines, and cell-phones are among those.

Unexamined Japanese Patent Application Kokai Publication No. 2002-287863 (Patent Literature 1, hereafter) discloses a display input system displaying or symbolizing an input field according to the input status on a displayed input part. The technique of the Patent Literature 1 determines the presence/absence of operation on an input field and, if there is no operation, displays the input field in a symbol displayed in a reduced size. On the other hand, if a given operation is conducted on the symbol, the symbolized input field is restored to the original size.

Unexamined Japanese Patent Application Kokai Publication No. 2002-297293 (Patent Literature 2, hereafter) discloses a portable information terminal device on which the software keyboard is displayed on the screen in a variable size according to the key input. The technique of the Patent Literature 2 provides an enlarge/reduce key on the screen. As the user presses the enlarge key, the software keyboard displayed on the screen is enlarged from a reduced size. On the other hand, as the user presses the reduce key, the software keyboard displayed on the screen is reduced in size from an enlarged size.

Unexamined Japanese Patent Application Kokai Publication No. 2008-084144 (Patent Literature 3, hereafter) discloses a portable terminal device on which a set of operation keys displayed on the touch panel can easily be changed into a desired layout. The portable terminal device of the Patent Literature 3 detects a succession of shifting input by the user with respect to a point within the display area of a set of operation keys displayed on the display part as the origin. Then, the portable terminal device shifts the origin according to the succession of shifting input with respect to a point corresponding to the origin as the fixed point, and enlarges or reduces the display area of the set of operation keys according to the shift of the origin. Then, the portable terminal device enlarges or reduces the set of operation keys at least in part to change the layout of the set of operation keys.

Furthermore, the portable terminal device of the Patent Literature 3 determines whether the user has touched the touch panel with a finger or the like and, if there is no key input from the user, measures the time since the last key input. If there is no key input from the user after the measured time exceeds a given time period, the portable terminal device switches the display to the sleep mode.

The information processing device of Unexamined Japanese Patent Application Kokai Publication No. 2008-310824 (Patent Literature 4, hereafter) executes a zooming utility program according to operation on the enlarge or reduce button. Then, the information processing device searches for an active window displayed and changes the display mode of the display contents in the found active window. The technique of the Patent Literature 4, for example, updates display size information in the registry corresponding to the active window and enlarges the display contents stepwise or at a fixed scaling factor each time the enlarge button is operated.

Unexamined Japanese Patent Application Kokai Publication No. H5-265622 (Patent Literature 5, hereafter) discloses a screen switching control method for producing sound from a built-in speaker of a display device for a given time period upon keyboard operation for switching the screen so as to give notice of screen switching.

Unexamined Japanese Patent Application Kokai Publication No. H11-327715 (Patent Literature 6, hereafter) discloses an information processing device enabling the user to input information efficiently using icons and a set of operation keys displayed on the display screen. The information processing device described in the Patent Literature 6 detects the information input position specified by the user on the touch panel. Then, the information processing device displays a software keyboard somewhere other than the detected information input position.

The techniques of the above Patent Literature 1 to 3 relate to techniques for enlarging or reducing the area for entering codes for symbols (letters, numbers, etc.) or commands (the codes input area, hereafter) on a touch panel display screen.

However, for example, even if the size of the codes input area is reduced using the techniques of the above Patent Literature 1 to 3, a specific area is occupied on the display screen. Then, display of the codes input area and an area for displaying the symbols representing the entered codes (the symbols display area, hereafter) on a display screen causes a problem that the user has difficulty to view.

The Patent Literature 4 to 6 has no description regarding any means for solving the above problem.

### SUMMARY

The present invention is invented in view of the above problem and an exemplary object of the present invention is to provide a display control device, display control method, and recording medium capable of displaying a screen that is easy for the user to view.

In order to achieve the above object, the display control device according to a first exemplary aspect of the present invention includes:

a display means displaying a codes input area for the user to enter codes and a symbols display area displaying the symbols representing the codes entered by the user;

a reception means receiving input of codes from the user as the user touches the codes input area;

a first determination means determining whether a first time has elapsed since the last touch by the user to the codes input area;

a deletion means deleting the display of the codes input area when the first determination means determines that the first time has elapsed;

an extension means extending the symbols display area after the display of the codes input area is deleted;

a second determination means determining whether a given condition for redisplaying the codes input area is satisfied; and

a redisplay means restoring the symbols display area to the pre-extension form and redisplaying the codes input area when the second determination means determines that the given condition is satisfied.

In order to achieve the above object, the display control method according to a second exemplary aspect of the present invention is:

a display control method executed by a display control device including a display means displaying a codes input area for the user to enter codes and a symbols display area displaying the symbols representing the codes entered by the user, including:

a reception step of receiving input of codes from the user as the user touches the codes input area;

a first determination step of determining whether a first time has elapsed since the last touch by the user to the codes input area;

a deletion step of deleting the display of the codes input area when it is determined in the first determination step that the first time has elapsed;

an extension step of extending the symbols display area after the display of the codes input area is deleted;

a second determination step of determining whether a given condition for redisplaying the codes input area is satisfied; and

a redisplay step of restoring the symbols display area to the pre-extension form and redisplaying the codes input area when it is determined in the second determination step that the given condition is satisfied.

In order to achieve the above object, the recording medium according to a third exemplary aspect of the present invention includes programs recorded thereon that allow a computer to function as:

a display means displaying a codes input area for the user to enter codes and a symbols display area displaying the symbols representing the codes entered by the user;

a reception means receiving input of codes from the user as the user touches the codes input area;

a first determination means determining whether a first time has elapsed since the last touch by the user to the codes input area;

a deletion means deleting the display of the codes input area when the first determination means determines that the first time has elapsed;

an extension means extending the symbols display area after the display of the codes input area is deleted;

a second determination means determining whether a given condition for redisplaying the codes input area is satisfied; and

a redisplay means restoring the symbols display area to the pre-extension form and redisplaying the codes input area when the second determination means determines that the given condition is satisfied.

The present invention is capable of displaying a screen that is easy for the user to view.

### BRIEF DESCRIPTION OF THE DRAWINGS

These objects and other objects and advantages of the present invention will become more apparent upon reading of the following detailed description and the accompanying drawings in which:

FIG. 1 is a block diagram showing an exemplary hardware configuration of the display control device according to an embodiment;

FIG. 2 is a block diagram showing an exemplary functional configuration of the display control device according to the embodiment;

FIG. 3 is an illustration showing an exemplary application screen displaying the symbols display area and a software keyboard according to the embodiment;

FIG. 4 is an illustration showing an exemplary application screen displaying only the symbols display area according to the embodiment; and

FIG. 5 is a flowchart showing an exemplary display control procedure according to the embodiment.

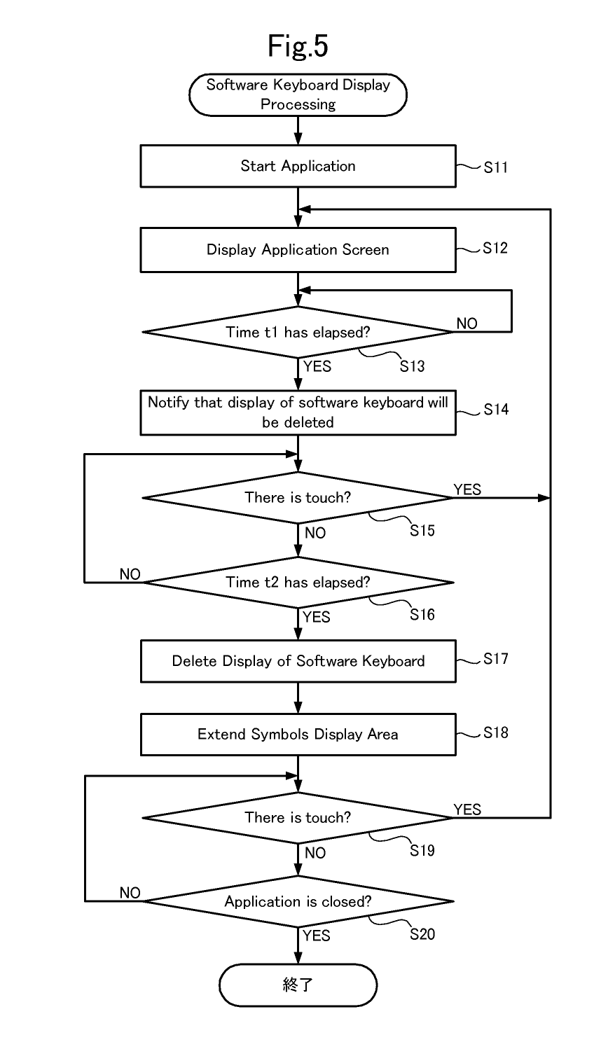

### EXEMPLARY EMBODIMENT

A mode for implementing the invention will be described in detail hereafter with reference to the drawings.

In this embodiment, the codes input area consists of a software keyboard. The software keyboard realizes input originally conducted through a hardware keyboard with software. Furthermore, in this embodiment, a first time is referred to as a time t1 and a second time is referred to as a time t2.

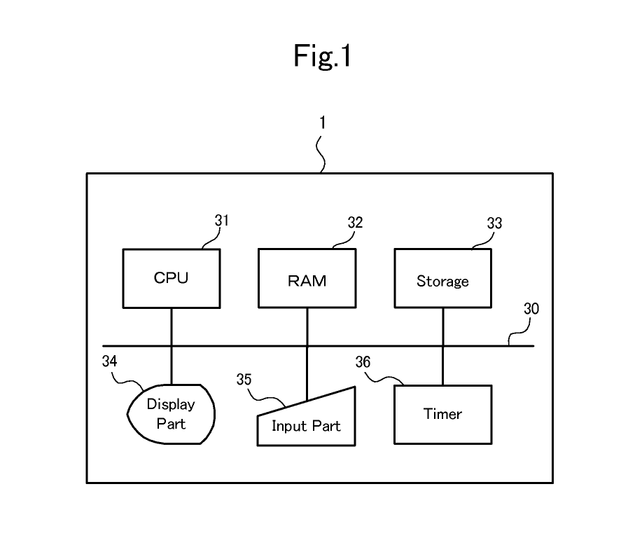

FIG. 1 is a block diagram showing an exemplary hardware configuration of a display control device 1 according to an embodiment. As shown in FIG. 1, the display control device 1 comprises a CPU 31, a RAM 32, a storage 33, a display part 34, an input part 35, and a timer 36, which are connected to each other via an internal bus 30.

Among them, the CPU 31 (central processing unit) is a central processing unit controlling the display control device 1 according to control programs stored in the storage 33.

The RAM 32 (random-access memory) is a volatile memory used as the work area of the CPU 31 that loads control programs stored in the storage 33.

The storage 33 is a nonvolatile memory such as a flash memory, hard disc, DVD-RAM (digital versatile disc random-access memory), and DVD-RW (digital versatile disc rewritable).

The storage 33 stores the control programs to be executed by the CPU 31 in advance. Furthermore, the storage 33 stores data presenting the values of the times t1 and t2 and data for screens to be displayed on the display part 34 in advance.

Furthermore, the storage 33 supplies data to the CPU 31 or stores data supplied from the CPU 31 according to instruction from the CPU 31.

The display part 34 is a display means consisting of a liquid crystal panel or the like and displaying application screens and the like based on the screen data.

The input part 35 is an input means such as a touch pad provided on the surface of the display part 34. In this embodiment, the display part 34 consisting of a liquid crystal panel or the like and the input part 35 consisting of a touch pad or the like are integrated. The display part 34 consisting of a liquid crystal panel or the like and the input part 35 consisting of a touch pad or the like are collectively termed a touch panel in the following explanation. The user touches a software keyboard displayed on the touch panel to enter codes for symbols (letters, numbers, etc.)

The timer 36 is a timing means measuring the time. Furthermore, the timer 36 periodically supplies the current time to the CPU 31 via the internal bus 30.

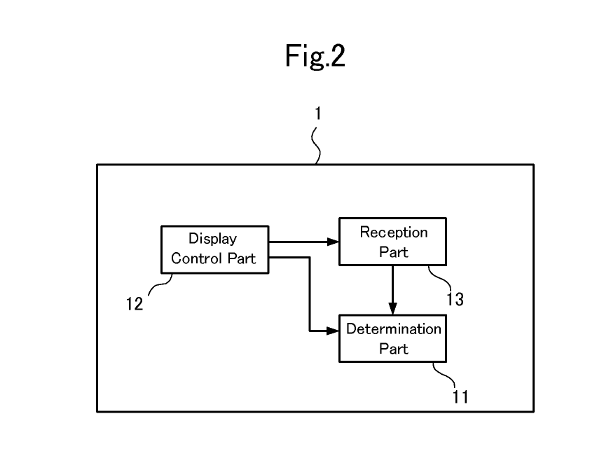

Here, the CPU 31 reads control programs in the storage 33, loads them on the RAM 32, and controls the display control device 1 according to the control programs. Consequently, the CPU 31 can exert the functions of the parts shown in FIG. 2. Functionally, as shown in FIG. 2, the display control device 1 comprises a display control part 11, a reception part 12, and a determination part 13. Here, the CPU 31 is the main executer of the functions of the parts. However, for convenience of explanation, the function of each part will be described as the main executer in the following explanation.

First, the display control part 11 controls screens to display on the display part 34. For example, if the user starts an application for entering symbols (letters, numbers, etc) or commands, the display control part 11 reads data for an application screen including a symbols display area displaying the symbols entered by the user and a software keyboard from the storage 33, and displays the application screen on the display part 34.

The reception part 12 is a reception means receiving input operation by the user on the input part 35. More specifically, the reception part 12 receives input of a code for a symbol (letter, number, etc.) or command as the user touches the software keyboard displayed on the touch panel.

The display control part 11 recognizes the code for the entered symbol (letter, number, etc.) or command based on the input of the code received by the reception part 12. Then, the display control part 11 displays the symbol representing the code entered by the user at a given position in the symbols display area.

The determination part 13 makes reference to the time t1 stored in the storage 33 and determines whether the time t1 has elapsed since the last touch on the software keyboard displayed on the touch panel. Here, if that the determination part 13 determined that the time t1 has elapsed since the last touch on the software keyboard, the display control part 11 displays a massage giving notice that the software keyboard will be deleted. Then, the determination part 13 makes reference to the time t2 stored in the storage 33 and determines whether the time t2 has elapsed without any touch on the software keyboard since the display control part 11 displayed the message on the touch panel. Here, the determination part 13 determines whether the time t1 and time t2 have elapsed by measuring the time by means of the timer 36.

Here, if the determination part 13 determined that the time t2 has elapsed without any touch on the software keyboard, the display control part 11 deletes the software keyboard from the application screen. At the same time, the display control part 11 extends the symbols display area over the region where the software keyboard was displayed on the application screen.

Furthermore, if the display control part 11 has deleted the software keyboard from the application screen and extended the symbols display area, in such a case, the determination part 13 determines whether the user has touched the symbols display area displayed on the touch panel. Here, if the determination part 13 determined that the user has touched the symbols display area, in such a case, the display control part 11 redisplays the software keyboard on the application screen and restores the symbols display area to the pre-extension form.

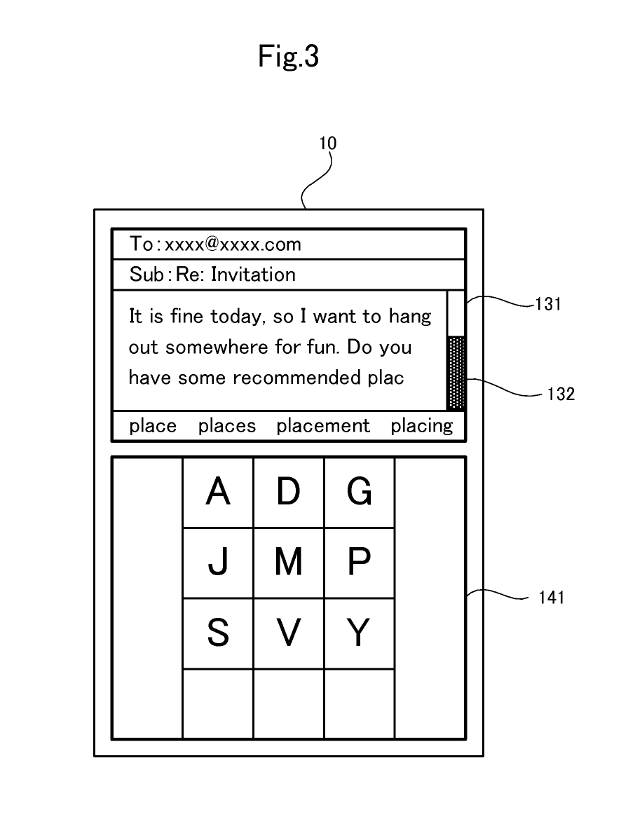

An exemplary application screen will be described hereafter with reference to FIG. 3. FIG. 3 shows an exemplary email message creation screen of an email application. A symbols display area 131 displaying the symbols (letters, numbers, etc.) entered by the user is displayed in the upper part of an email message creation screen displayed on the touch panel 10. Furthermore, a software keyboard 141 that is a codes input area is displayed in the lower part of the touch panel 10.

The software keyboard 141 includes English alphabetical letter keys “A,” “D,” “G,” “J,” “M,” “P,” “S,” “V,” and “Y.” The other alphabetical letters are displayed by touching the corresponding key multiple times. For example, for entering “plac,” the user touches the key “P” one time, the key “J” three times, the key “A” one time, and the key “A” three times on the software keyboard 141. Then, the letters “plac” are displayed in the symbols display area 131, and anticipated words “place, places, placement, placing” are displayed in the bottom part of the symbols display area 131. If the intended word is among the anticipated words, the user touches the word to enter it.

When the text entered by the user exceeds the display range of the symbols display area 131, a scroll bar 132 is displayed at one side. For viewing the characters of the part that is not displayed in the symbols display area 131, the user touches the symbols display area 131. Then, the user keeps the touch and slides for scrolling the symbols display area 131, whereby the characters of the part that was not displayed are displayed. Here, the software keyboard 141 can have some other keyboard arrangement such as the Qwerty arrangement.

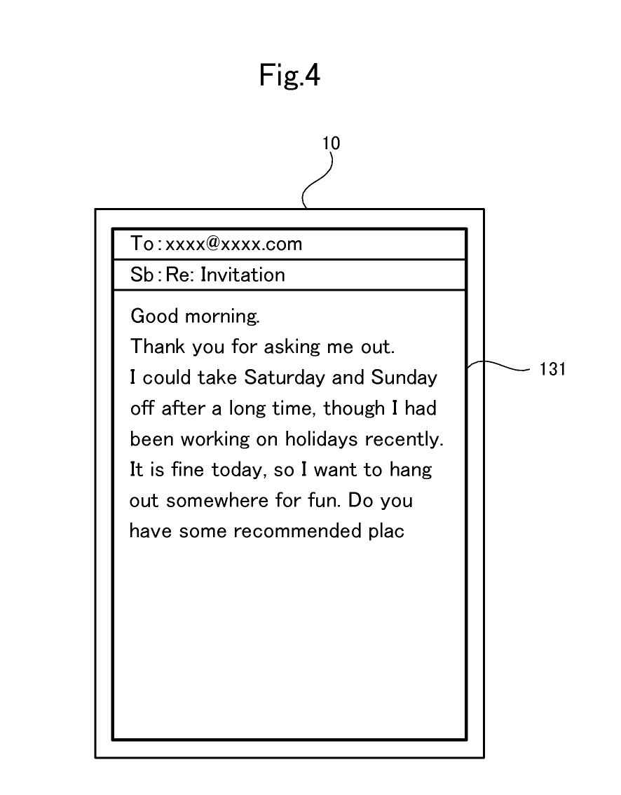

FIG. 4 is an illustration showing an exemplary application screen displaying only the symbols display area according to the embodiment. If the time t1 has elapsed without any touch by the user on the software keyboard 141 while the software keyboard 141 is displayed as shown in FIG. 3, in such a case, the display control part 11 displays on the email message creation screen a massage giving notice that the software keyboard 141 will be deleted. Furthermore, if the time t2 has elapsed without any touch by the user on the software keyboard 141, in such a case, as shown in FIG. 4, the display control part 11 deletes the display of the software keyboard 141 and extends the symbols display area 131 over the region where the software keyboard 141 was displayed.

The display control procedure will be described hereafter with reference to the flowchart of FIG. 4. Here, the display control procedure is implemented by the CPU 31 executing control programs stored in the storage 33 and exerting the functions of the display control part 11, reception part 12, and determination part 13 shown in FIG. 2.

First, the CPU 31 starts an application in response to a touch operation by the user on the touch panel 10 (Step S11). Here, for example, the CPU 31 starts an email application in response to a touch operation by the user on the touch panel 10.

Then, the CPU 31 reads screen data from the storage 33, and displays on the touch panel an application screen including the symbols display area 131 and software keyboard 141 (Step S12). More specifically, the CPU 31 displays an email message creation screen of an email application as shown in FIG. 3.

Next, the CPU 31 determines whether the time t1 has elapsed since the last touch by the user on the software keyboard 141 displayed on the touch panel (Step S13). Here, if the time t1 has not elapsed (Step S13, NO), the CPU 31 repeats the Step S13.

On the other hand, if the time t1 has elapsed (Step S13; YES), the CPU 31 displays on the application screen a massage indicating that the display of the software keyboard 141 will be deleted to notify the user (Step S14). Here, the massage means that the display of the software keyboard 141 will be deleted after the time t2 has elapsed. If the user knows that it is after the time t2 has elapsed that the display of the software keyboard 141 is deleted, the message can simply means that the display of the software keyboard 141 will be deleted.

Next, the CPU 31 determines whether the user has touched the software keyboard 141 displayed on the touch panel (Step S15). More specifically, the CPU 31 determines whether there is any touch by the user on the software keyboard 141 by means of the function of the reception part 12.

Then, if the user has touched the software keyboard 141 (Step S15; YES), the CPU 31 returns to the Step S12 and repeats the Steps S12 to S15.

On the other hand, if the user has not touched the software keyboard 141 (Step S15; NO), the CPU 31 determines whether the time t2 has elapsed (Step S16). If the time t2 has not elapsed (Step S16; NO), the CPU 31 returns to the Step S15 and repeats the Steps S15 and 16. If the time t2 has elapsed (Step S16; YES), the CPU 31 deletes the display of the software keyboard 141 on the application screen (Step S17). At the same time, the CPU 31 extends the symbols display area 131 on the application screen (Step S18).

In other words, the CPU 31 determines whether there is any touch by the user while displaying the message indicating that the display of the software keyboard 141 will be deleted until the time t2 has elapsed. If there is any touch by the user before the time t2 has elapsed, the CPU 31 deletes the displayed message and restores the application screen shown in FIG. 3. On the other hand, if there is no touch by the user before the time t2 has elapsed, the CPU 31 displays the application screen on which the symbols display area 131 is extended as shown in FIG. 4.

Next, the CPU 31 determines whether the user has touched the symbols display area 131 displayed on the touch panel (Step S19). More specifically, the CPU 31 determines whether there is any touch by the user to the symbols display area 131 by means of the function of the reception part 12.

If the user has touched the symbols display area 131 (Step S19; YES), the CPU 31 returns to the Step S12 and repeats the Steps S12 to 19. On the other hand, if the user has not touched the symbols display area 131 (Step S19; NO), the CPU 31 determines whether the user has closed the application (Step S20). If the user has not closed the application (Step S20; NO), the CPU 31 returns to the Step S19 and repeats the Steps S19 and S20. If the user has closed the application (Step S20; YES), the CPU 31 ends the procedure.

In other words, the CPU 31 determines whether there is any touch by the user while keeping the application screen shown in FIG. 4 on which the symbols display area 131 is extended (Step S18) until the user closes the email application. Then, if there is any touch by the user, the CPU 31 restores the application screen shown in FIG. 3.

Here, the values of the times t1 and t2 can be preset or set by the user through the touch panel 10 on an arbitrary basis. Furthermore, at the time when the time t1 has elapsed since the last touch on the software keyboard 141, the user has already suspended input operation for the time t1. Therefore, it is preferable that the time until the software keyboard 141 is deleted since the message is displayed on the touch panel is shorter. Then, it is recommended to satisfy the time t1>the time t2 or the time t1>>the time t2.

Of the processing of the steps in FIG. 7, the processing of the Steps S11, S12, S14, S17, S18, and S20 corresponds to the function of the display control part 11, and the processing of the Steps S15 and 19 corresponds to the function of the reception part 12, and the processing of the Steps S13 and 16 corresponds to the function of the determination part 13.

As described above, provided with the functions of the display control part 11, reception part 12, and determination part 13, the display control device of the embodiment deletes the software keyboard 141 and extends the symbols display area 131 when there is no input operation by the user. In this way, the user can view the entered text in an extended area, providing screen display that is easy for the user to view. Particularly while the user is thinking and suspending input operation on the touch panel, the capability of viewing the text entered until then in an extended area is preferable.

An embodiment is described above. The hardware configuration and flowchart of the display control device 1 are given by way of example and any change and modification can be made.

In this embodiment, after the time t1 has elapsed since the last touch by the user on the software keyboard 141, a massage indicating that the software keyboard 141 will be deleted will be displayed on the application screen to notify the user. Then, after the time t2 has elapsed without any touch on the software keyboard 141, the display of the software keyboard 141 is deleted. This is not restrictive. For example, the display of the software keyboard 141 can be deleted at the time when the time t1 has elapsed since the last touch by the user on the software keyboard 141.

The determination whether the time t1 has elapsed does not need to be based on the software keyboard 141. For example, the time t1 can be measured since the last touch on the touch panel (for example, including the touching and sliding for scrolling the symbols display area 131). Furthermore, the determination whether the time t2 has elapsed can be based on whether the time t2 has elapsed without any touch on the entire touch panel.

Furthermore, in this embodiment, the display control part 11 displays on the application screen a message indicating that the display of the software keyboard 141 will be deleted to notify the user. This is not restrictive. It is possible to reduce the size of the display of the software keyboard 141 stepwise and eventually delete it, or utilize a sound effect. Alternatively, it is possible to blink the display of the software keyboard 141 or change the color of the display of the software keyboard 141. Furthermore, it is possible to blink a lamp such as an LED.

Furthermore, in this embodiment, a touch to the symbols display area 131 of the application screen shown in FIG. 4 triggers the restoration to the application screen shown in FIG. 3. The touch is not the only thing to trigger. For example, the display control device 1 is provided with an acceleration sensor. Then, acceleration equal to or greater than a given value may trigger the restoration to the application screen shown in FIG. 3 from the application screen shown in FIG. 4 regardless of the touch. Alternatively, if there is some area other than the symbols display area 131 on the application screen shown in FIG. 4, a touch to the area other than the symbols display area 131 may trigger the restoration to the application screen shown in FIG. 3.

Furthermore, when the symbols entered by the user exceeds the extended symbols display area 131 shown in FIG. 4, a scroll bar can be displayed also in the extended symbols display area 131. In such a case, the user touches and slides the symbols display area 131 to scroll the symbols display area 131. This is not the operation to display the software keyboard 141. Then, the determination part 13 distinguishes the action of touching the touch panel from the action of touching and sliding the touch panel. In the case of the action of touching and sliding, the action does not trigger the redisplay of the software keyboard 141 on the application screen.

Furthermore, in this embodiment, a touch-type software keyboard is used as the codes input area. This is not restrictive. For example, instead of receiving input through touch by the user with a finger, the reception part 12 can receive input through enter operation with a cursor displayed on the display part 34. For the enter operation with a cursor, the user can use, for example, a controller provided with arrow keys and an enter key or a mouse instead of the input part 35 such as a touch pad.

Furthermore, the above-described functions of the display control device 1 can be realized using a conventional computer. For example, computer programs for executing the display control procedure can be stored and distributed on a computer-readable recording medium (flexible disc, CD-ROM, DVD-ROM, and so on). Then, the computer programs are installed on a computer so as to allow the CPU of the computer to execute the display control procedure. Alternatively, the computer programs can be stored in a storage device of a server unit on a communication network such as the Internet and downloaded on a conventional computer, whereby the computer can execute the functions of the display control device 1.

Furthermore, when the functions of the display control device 1 are realized by apportionment between an OS (operation system) and application programs or cooperation of an OS and application programs, only the application programs can be stored on a recording medium or in a storage device.

Furthermore, the computer programs can be superimposed on carrier waves to distribute them via a communication network. For example, the computer programs can be posted on a bulletin board system (BBS) of a communication network to distribute them via the network. Then, a computer on which the computer programs are installed activates the computer programs and executes the display control procedure under the control of an OS in a manner similar to executing other application programs.

This embodiment can partly or entirely, but not exclusively, described as follows.

(Supplementary Note 1)

A display control device, including:

a display means displaying a codes input area for the user to enter codes and a symbols display area displaying the symbols representing the codes entered by the user;

a reception means receiving input of codes from the user as the user touches the codes input area;

a first determination means determining whether a first time has elapsed since the last touch by the user to the codes input area;

a deletion means deleting the display of the codes input area when the first determination means determines that the first time has elapsed;

an extension means extending the symbols display area after the display of the codes input area is deleted;

a second determination means determining whether a given condition for redisplaying the codes input area is satisfied; and

a redisplay means restoring the symbols display area to the pre-extension form and redisplaying the codes input area when the second determination means determines that the given condition is satisfied.

(Supplementary Note 2)

The display control device according to Supplementary note 1, further including:

a notification means notifying the user that the display of the codes input area will be deleted when the first determination means determines that the first time has elapsed; and

a third determination means determining whether a second time has elapsed after the notification means starts notifying the user,

wherein the deletion means deletes the display of the codes input area when the third determination means determines that the second time has elapsed.

(Supplementary Note 3)

The display control device according to Supplementary note 2, wherein:

the notification means notifies the user that the display of the codes input area will be deleted by reducing the size of the display of the codes input area stepwise when the first determination means determines that the first time has elapsed.

(Supplementary Note 4)

The display control device according to Supplementary note 2 or 3, further including:

an output means outputting a sound effect,

wherein the notification means notifies the user that the display of the codes input area will be deleted by making the output means output the sound effect when the first determination means determines that the first time has elapsed.

(Supplementary Note 5)

The display control device according to any one of Supplementary notes 2 to 4, wherein:

the notification means notifies the user that the display of the codes input area will be deleted by blinking the codes input area when the first determination means determines that the first time has elapsed.

(Supplementary Note 6)

The display control device according to any one of Supplementary notes 2 to 5, wherein:

the notification means notifies the user that the display of the codes input area will be deleted by changing the color of the display of the codes input area when the first determination means determines that the first time has elapsed.

(Supplementary Note 7)

The display control device according to any one of Supplementary notes 2 to 6, further including:

an input means for the user to enter the first time and second time,

wherein the reception means receives the first time and second time entered by the user through the input means.

(Supplementary Note 8)

The display control device according to any one of Supplementary notes 2 to 7, wherein:

the second time is shorter than the first time.

(Supplementary Note 9)

The display control device according to any one of Supplementary notes 1 to 8, wherein:

the deletion means does not delete the display of the codes input area when a touch to an area other than the codes input area is detected even if the first determination means determines that the first time has elapsed.

(Supplementary Note 10)

The display control device according to any one of Supplementary notes 1 to 6, wherein:

the second determination means determines whether the user has touched the symbols display area at least one time, and

the redisplay means redisplays the codes input area when the second determination means determines that the user has touched the symbols display area at least one time.

(Supplementary Note 11)

The display control device according to any one of Supplementary notes 1 to 6, further including:

a detection means detecting the acceleration of the display control device,

wherein the second determination means determines whether the detection means has detected acceleration equal to or greater than a given value, and

the redisplay means redisplays the codes input area when the second determination means determines that the acceleration equal to or greater than a given value is detected.

(Supplementary Note 12)

A display control method executed by a display control device including a display means displaying a codes input area for the user to enter codes and a symbols display area displaying the symbols representing the codes entered by the user, including:

a reception step of receiving input of codes from the user as the user touches the codes input area;

a first determination step of determining whether a first time has elapsed since the last touch by the user to the codes input area;

a deletion step of deleting the display of the codes input area when it is determined in the first determination step that the first time has elapsed;

an extension step of extending the symbols display area after the display of the codes input area is deleted;

a second determination step of determining whether a given condition for redisplaying the codes input area is satisfied; and

a redisplay step of restoring the symbols display area to the pre-extension form and redisplaying the codes input area when it is determined in the second determination step that the given condition is satisfied.

(Supplementary Note 13)

The display control method according to Supplementary note 12, further including:

a notification step of notifying the user that the display of the codes input area will be deleted when it is determined in the first determination step that the first time has elapsed; and

a third determination step of determining whether the second time has elapsed after the notification to the user starts in the notification step,

wherein in the deletion step, the display of the codes input area is deleted when it is determined in the third determination step that the second time has elapsed.

(Supplementary Note 14)

The display control method according to Supplementary note 13, wherein:

in the notification step, the size of the display of the codes input area is reduced stepwise to notify the user that the display of the codes input area will be deleted when it is determined in the first determination step that the first time has elapsed.

(Supplementary Note 15)

The display control method according to Supplementary note 13 or 14, wherein:

the display control device further includes an output means outputting a sound effect, and

in the notification step, the output means is made to output the sound effect to notify the user that the display of the codes input area will be deleted when it is determined in the first determination step that the first time has elapsed.

(Supplementary Note 16)

The display control method according to any one of Supplementary notes 13 to 15, wherein:

in the notification step, the codes input area is blinked to notify the user that the display of the codes input area will be deleted when it is determined in the first determination step that the first time has elapsed.

(Supplementary Note 17)

The display control method according to any one of Supplementary notes 13 to 16, wherein:

in the notification step, the color of the display of the codes input area is changed to notify the user that the display of the codes input area will be deleted when it is determined in the first determination step that the first time has elapsed.

(Supplementary Note 18)

The display control method according to any one of Supplementary notes 13 to 17, further including:

an input means for the user to enter the first time and second time,

wherein the reception step includes a step of receiving the first time and second time entered by the user through the input means.

(Supplementary Note 19)

The display control method according to any one of Supplementary notes 13 to 18, wherein:

the second time is shorter than the first time.

(Supplementary Note 20)

The display control method according to any one of Supplementary notes 12 to 19, wherein:

in the deletion step, the display of the codes input area is not deleted when a touch to an area other than the codes input area is detected even if it is determined in the first determination step that the first time has elapsed.

(Supplementary Note 21)

The display control method according to any one of Supplementary notes 12 to 17, wherein:

in the second determination step, it is determined whether the user has touched the symbols display area at least one time, and

in the redisplay step, the codes input area is redisplayed when it is determined in the second determination step that the user has touched the symbols display area at least one time.

(Supplementary Note 22)

The display control method according to any one of Supplementary notes 12 to 17, further including:

a detection step of detecting the acceleration of the display control device,

wherein in the second determination step, it is determined whether acceleration equal to or greater than a given value is detected in the detection step, and

in the redisplay step, the codes input area is redisplayed when it is determined in the second determination step that the acceleration equal to or greater than a given value is detected.

(Supplementary Note 23)

A recording medium on which programs are recorded that allow a computer to function as:

a display means displaying a codes input area for the user to enter codes and a symbols display area displaying the symbols representing the codes entered by the user;

a reception means receiving input of codes from the user as the user touches the codes input area;

a first determination means determining whether a first time has elapsed since the last touch by the user to the codes input area;

a deletion means deleting the display of the codes input area when the first determination means determines that the first time has elapsed;

an extension means extending the symbols display area after the display of the codes input area is deleted;

a second determination means determining whether a given condition for redisplaying the codes input area is satisfied; and

a redisplay means restoring the symbols display area to the pre-extension form and redisplaying the codes input area when the second determination means determines that the given condition is satisfied.

Having described and illustrated the principles of this application by reference to one or more preferred embodiments, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

1. A display control device, comprising:
a display means displaying a codes input area for the user to enter codes and a symbols display area displaying the symbols representing the codes entered by said user;
a reception means receiving input of codes from said user as the user touches said codes input area;
a first determination means determining whether a first time has elapsed since the last touch by said user to said codes input area;
a deletion means deleting the display of said codes input area when said first determination means determines that said first time has elapsed;
an extension means extending said symbols display area after the display of said codes input area is deleted;
a second determination means determining whether a given condition for redisplaying said codes input area is satisfied; and
a redisplay means restoring said symbols display area to the pre-extension form and redisplaying said codes input area when said second determination means determines that said given condition is satisfied.

2. The display control device according to claim 1, further comprising:
a notification means notifying the user that the display of said codes input area will be deleted when said first determination means determines that said first time has elapsed; and
a third determination means determining whether a second time has elapsed after said notification means starts notifying said user,
wherein said deletion means deletes the display of said codes input area when said third determination means determines that said second time has elapsed.

3. The display control device according to claim 2, wherein:
said notification means notifies the user that the display of said codes input area will be deleted by reducing the size of the display of said codes input area stepwise when said first determination means determines that said first time has elapsed.

4. The display control device according to claim 2, further comprising:
an output means outputting a sound effect,
wherein said notification means notifies the user that the display of said codes input area will be deleted by making said output means output said sound effect when said first determination means determines that said first time has elapsed.

5. The display control device according to claim 2, wherein:
said notification means notifies the user that the display of said codes input area will be deleted by blinking said codes input area when said first determination means determines that said first time has elapsed.

6. The display control device according to claim 2, wherein:
said notification means notifies the user that the display of said codes input area will be deleted by changing the color of the display of said codes input area when said first determination means determines that said first time has elapsed.

7. The display control device according to claim 1, wherein:
said second determination means determines whether said user has touched said symbols display area at least one time, and
said redisplay means redisplays said codes input area when said second determination means determines that said user has touched said symbols display area at least one time.

8. The display control device according to claim 1, further comprising:
a detection means detecting the acceleration of said display control device,
wherein said second determination means determines whether said detection means has detected acceleration equal to or greater than a given value, and
said redisplay means redisplays said codes input area when said second determination means determines that said acceleration equal to or greater than a given value is detected.

9. A display control method executed by a display control device comprising a display means displaying a codes input area for the user to enter codes and a symbols display area displaying the symbols representing the codes entered by said user, comprising:
a reception step of receiving input of codes from said user as the user touches said codes input area;
a first determination step of determining whether a first time has elapsed since the last touch by said user to said codes input area;
a deletion step of deleting the display of said codes input area when it is determined in said first determination step that said first time has elapsed;
an extension step of extending said symbols display area after the display of said codes input area is deleted;
a second determination step of determining whether a given condition for redisplaying said codes input area is satisfied; and
a redisplay step of restoring said symbols display area to the pre-extension form and redisplaying said codes input area when it is determined in said second determination step that said given condition is satisfied.

10. A recording medium on which programs are recorded that allow a computer to function as:
a display means displaying a codes input area for the user to enter codes and a symbols display area displaying the symbols representing the codes entered by said user;
a reception means receiving input of codes from said user as the user touches said codes input area;
a first determination means determining whether a first time has elapsed since the last touch by said user to said codes input area;
a deletion means deleting the display of said codes input area when said first determination means determines that said first time has elapsed;
an extension means extending said symbols display area after the display of said codes input area is deleted;
a second determination means determining whether a given condition for redisplaying said codes input area is satisfied; and
a redisplay means restoring said symbols display area to the pre-extension form and redisplaying said codes input area when said second determination means determines that said given condition is satisfied.
